(19) United States
(12) Patent Application Publication
(10) Pub. No.: US 2022/0385163 A1
(43) Pub. Date: Dec. 1, 2022

(54) Infinity Electrical Reactor (IER) Device

(71) Applicant: Marvin Leonard Bishop, Salt Lake City, UT (US)

(72) Inventor: Marvin Leonard Bishop, Salt Lake City, UT (US)

(73) Assignee: Marvin Bishop, Salt Lake City, UT (US)

(21) Appl. No.: 17/724,222

(22) Filed: Apr. 19, 2022

Related U.S. Application Data
(60) Provisional application No. 63/258,547, filed on May 10, 2021.

(51) Int. Cl. H02K 53/00

(52) U.S. Cl. CPC H02K 53/00

(57) ABSTRACT

An infinity electrical reactor system is described. Embodiments of the infinity electrical reactor system include, but are not limited to, a first electric motor, a friction motor, a second electric motor, a third electric motor, a converter, a step-up transformer, and a current multiplier. An axle can be implemented to operatively connect the first electric motor, the friction motor, the second electric motor, and the third electric motor.

### BRIEF DESCRIPTION OF THE DRAWINGS

FIG. 1 is block diagram of an infinity electrical reactor device according to one embodiment of the present invention.

FIG. 2 is block diagram of an infinity electrical reactor device according to one embodiment of the present invention.

### DETAILED DESCRIPTION

In one embodiment, the Infinity electrical Reactor (IER) device is a self-propulsion, friction motor powered, electrical feedback, continuous running, electric generator made from small electric motors and a spinning weighted wheel/flywheel (friction motor).

When the IER device is hooked up to a step-up-transformer and a current multiplier, the IER device can run anything/everything (e.g., Homes, Autos, trains, planes, helicopters, farm, transportation, construction, agricultural and recreational equipment.) Anything and everything that runs off of electricity.

To implement the IER device, a friction motor can be started by spinning a heavy weighted metal wheel/flywheel of the friction motor and friction motor can start the IER device. A centripetal force of the weighted wheel can generate electricity in a small electric motor. The electricity is fed back to a slightly larger, but still small, electric motor. As can be appreciated, all three of the motors can reach equilibrium speeds of 3 volts.

Formula

F_c=\frac{mv∧2}{r}=mv squared/r

F_c=centripetal force

m=mass

v=velocity

r=radius

A fourth small 3 volt electric motor can feed its electricity to a 120 volt step-up transformer. The step-up transformer can feed its electricity to a 250 amp current multiplier. Then all this goes to power the home.

I agree with the scientific community. There is no such thing as a Perpetual Motion Machine (PMM). You have to put energy into something in order to get energy out of it. My Innovation is a Continual Motion Machine (CMM). It does not violate Newton's laws of Motion like a PMM would.

The friction motor can be a heavy metal weighted wheel on an axel that when suspended on frictionless mounts can use centripetal force to defy gravity and spin a little longer.

A First Embodiment of an Infinity Electrical Reactor Device

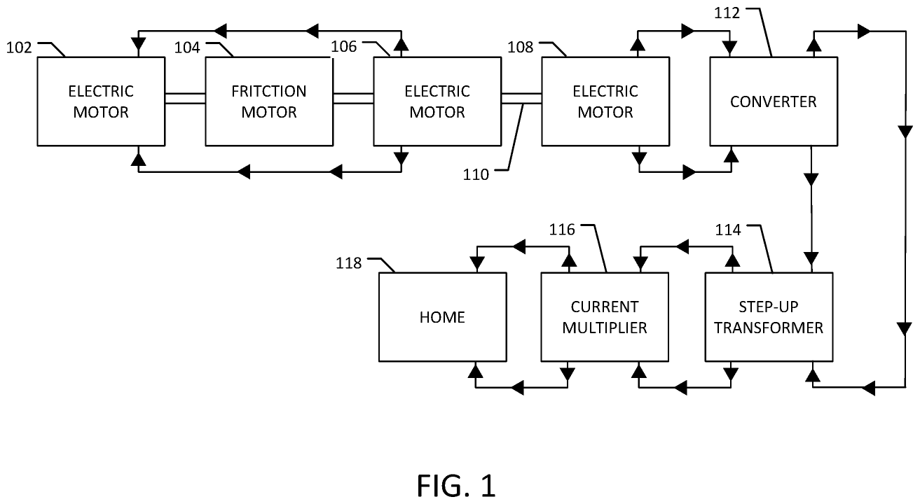

Referring to FIG. 1, a block diagram of a first embodiment 100 of an infinity electrical reactor (IER) device is illustrated. Embodiments of the infinity electrical reactor device 100 can be implemented to power a home.

As shown, the infinity electrical reactor device 100 can include, but is not limited to, a first electrical motor/generator 102, a friction motor 104, a second electrical motor/generator 106, a third electrical motor/generator 108, an axle 110, a converter 112, a step-up transformer 114, and a current multiplier 116. The infinity electrical reactor device 100 can be operatively connected to an electrical system of a home 118. Typically, each of the electrical motors/generators 102, 106, 108 can be direct current (DC) producing motor/generators.

The first electrical motor/generator 102, the friction motor 104, the second electrical motor/generator 106, and the third electrical motor/generator 108 can be operatively connected to one another via the axle 110. The third electrical motor/generator 108 can be electrically connected to the converter 112. The converter 112 can be electrically connected to the step-up transformer 114. The step-up transformer 114 can be electrically connected to the current multiplier 116. The current multiplier 116 can be electrically connected to the home 118.

In one embodiment, the first electric motor/generator 102 can be a 3-6 volt motor, the second motor 104 can be a weighted wheel friction motor, the second electric motor/generator 106 can be a 1.5-3 volt motor, and the third electric motor/generator 108 can be a 1.5-3 volt motor. The converter 112 can be an DC-to-AC converter. The step-up transformer 114 can be a 120 volt transformer. The current multiplier 116 can be a 250 amp current multiplier. In one example, a centripetal force of the weighted wheel can rotate the axle 110 to generate electricity in the second electric motor/generator 106. The electricity can be fed back to first electric motor/generator 102. As can be appreciated, all three of the motors 102, 104, 106 can reach equilibrium speeds of 3 volts.

In a typical implementation, the friction motor 104 can be started to begin the device 100. As can be appreciated, when the friction motor 104 is started, the axle 110 can be rotated which can start the second electrical motor/generator 106 and the first electrical motor/generator 102. Power generated by the second electrical motor/generator 106 can be fed back to the first electrical motor/generator 102. As the axle 110 rotates, the third electrical motor/generator 108 can generate electricity which can be fed to the converter 112. The step-up transformer 114 can receive electricity from the converter 112. The current multiplier 116 can receive current from the step-up transformer 114.

A Second Embodiment of an Infinity Electrical Reactor Device

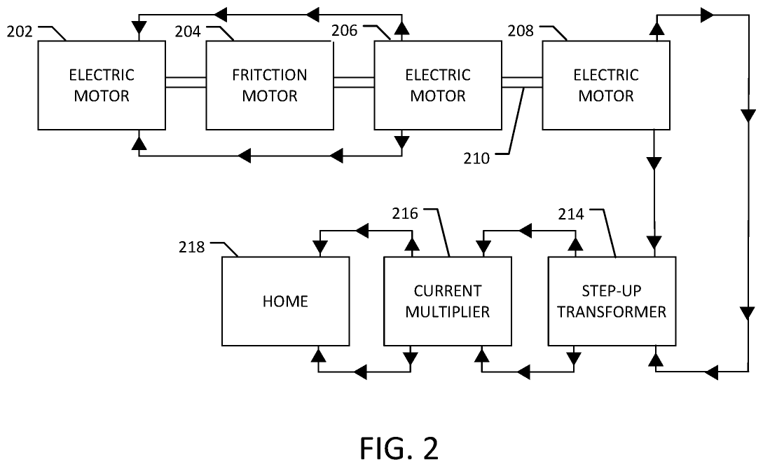

Referring to FIG. 2, a block diagram of a second embodiment 200 of an infinity electrical reactor (IER) device is illustrated. Embodiments of the infinity electrical reactor device 200 can be implemented to power a home.

As shown, the infinity electrical reactor device 200 can be similar to the first embodiment infinity electrical reactor device 100. The second embodiment infinity electrical reactor device 200 can include, but is not limited to, a first electrical motor/generator 202, a friction motor 204, a second electrical motor/generator 206, a third electrical motor/generator 208, an axle 210, a step-up transformer 214, and a current multiplier 216. The infinity electrical reactor device 200 can be operatively connected to an electrical system of a home 218.

The second embodiment IER device 200 can be operated substantially similar to the first embodiment IER 100, but can include an alternate current (AC) producing electrical motor/generator for the third electrical motor/generator 208. As can be appreciated, this can alleviate the need for a converter.

I claim:

1. An infinity electrical reactor device comprising:
a first electric motor;
a friction motor;
a second electric motor electrically connected to the first electric motor;
a third electric motor;
an axle operatively connected to the first electric motor, the friction motor, the second electric motor, and the third electric motor;
a DC-to-AC converter adapted to receive electricity from the third electrical motor;
a step-up transformer electrically connected to the DC-to-AC converter; and
a current multiplier electrically connected to the step-up transformer.

2. The infinity electrical reactor device of claim 1, wherein the first electric motor is a 3-6 volt motor.

3. The infinity electrical reactor device of claim 1, wherein the second electric motor is a 1.5-3 volt motor.

4. The infinity electrical reactor device of claim 1, wherein the third electric motor is a 1.5-3 volt motor.

5. The infinity electrical reactor device of claim 1, wherein the step-up transformer is a 120 volt step-up transformer.

6. An infinity electrical reactor device comprising:
a first electric motor;
a friction motor;
a second electric motor electrically connected to the first electric motor;
a third electric motor;
an axle operatively connected to the first electric motor, the friction motor, the second electric motor, and the third electric motor;
a step-up transformer electrically connected to the third electric motor; and
a current multiplier electrically connected to the step-up transformer.
